(19) United States
(12) Patent Application Publication
(10) Pub. No.: US 2022/0228808 A1
(43) Pub. Date: Jul. 21, 2022

(54) MULTIPLE-CHANNEL REFRIGERATED PANEL FOR BLAST FURNACES AND OTHER INDUSTRIAL FURNACES

(71) Applicant: CECAL TECNO IND E COMERCIO DE EQUIPAMENTOS SOB ENCOMENDA LTDA, Centro (BR)

(72) Inventor: Carlo Lorenzo Geronimi, Lorena (BR)

(73) Assignee: CECAL TECNO IND E COMERCIO DE EQUIPAMENTOS SOB ENCOMENDA LTDA, Centro (BR)

(21) Appl. No.: 17/609,831

(22) PCT Filed: May 9, 2019
(86) PCT No.: PCT/BR2019/050172

§ 371 Date: Nov. 9, 2021

(51) Int. Cl. F27B 1/24; F28F 3/12; F27D 9/00; C21B 7/10

(52) U.S. Cl. CPC F27B 1/24; F28F 3/12; F27D 9/00; F27D 2009/0013; F28F 2275/06; F27D 2009/0067; C21B 7/10

(57) ABSTRACT

This present invention is a cooled panel (23) used on the walls of blast furnaces (1) and other industrial furnaces consisting of a body (25) of copper, cast iron or other metal alloy, independent internal cooling channels (24) and protection sleeves (26) attached to the panel body and the pipes (27) that link the couplings to the internal cooling channels (24). The cooled panel (23) features the amount of internal cooling channels (24) greater than the number of coupling sets (31), which are connected to the furnace water system feeding and return (35).

### TECHNICAL FIELD

The present invention refers to a new cooled panel used on the walls of blast furnaces and other industrial furnaces destined to the production of iron, steel and other basic materials.

### STATE OF THE TECHNIQUE

Industrial furnaces destined to the production of iron, steel and other basic materials are medium and large equipment where the necessary chemical reactions for the production and/or refining of numerous raw materials and/or fusion for reprocessing materials occur. There are several types of industrial furnaces, however they are all characterized by the severe demands induced by the internal environment of the furnace on its inside walls. These demands are divided into thermal demands, caused by high temperatures, mechanical demands, mainly abrasion and impacts caused by the contact between furnace's load and the walls, and chemical demands (corrosion), generated by the chemical reactions between the material of the walls and the substances in the internal atmosphere of the furnace. The various types of demands can act simultaneously, each one potentializing the other's effect. Consequently, wear and deterioration of the furnace walls is one of the factors that determine the furnace's utile lifetime and/or the frequency and duration of maintenance stops. Indeed, various types of components, materials and applications have been developed in order to increase the wall's resistance facing these demands and thus maximizing their utile lifetime.

Among the solutions used in the current state of the art, cooled panels stand out. These panels are assembled on the inside walls of the furnace. The panels are made of copper, iron or other metal alloy and are cooled through water or other fluid circulation, from now on called “cooling water”. Cooling water circulates in internal channels in the panel, and the thermal exchange between the water and the internal surface of the channel removes the thermal load (heat) from the panel body sourced from inside the furnace in order to stabilize temperature and thus prevent the loss of mechanical properties and rapid deterioration of the panel.

The panel body may consist of a rolled, extruded, forged or cast block. When it is rolled, extruded or forged, cooling channels are obtained through machining (drilling), while when the body is cast, the channels can be obtained directly, through sand cores or through pipe coils that are positioned in the mold before melting. Coils are usually manufactured from copper, steel, or metal alloy pipes whose main components are copper and nickel. Each internal channel has a water inlet and outlet, which are connected to the furnace's cooling water circulation system.

In some types of furnaces, cooled panels are assembled in a support structure, which leaves the back of the panel partially in sight from outside of the furnace. In this case, panels work as side walls and furnace lining, being responsible for retaining gas and material inside the furnace and for avoiding heat dispersion. In this configuration, the combination of the support structure and the cooled panels that make up the walls is called the furnace shell. This is mainly the case of electric arc furnaces (FEA) and other types of furnaces destined to the production of base metals. In other cases, such as blast-furnaces for pig iron production and also some types of furnaces destined to the production of base metals, the panels are fixed on the inner side of a closed structure, consisting of steel plates, which totally insulates the inside of the furnace from the external environment. In these cases, the name shell applies to this closed structure and the function of the panels is to protect the shell from the demands coming from inside the furnace. In this configuration, the pipes that make up the inlets and outlets of the cooling water of the panels must necessarily cross the shell to connect with the furnace water circulation system. This situation generates the need to drill holes in the shell and seal the remaining space between the housing and the tube to prevent the passage of gases. This seal is made by welding rigid metal components or expansion joints. The expansion joints allow, to some extent, the relative displacement between tube and shell, without harming the seal.

The face of the panel that sits toward the center of the furnace, exposed directly to heat is called the hot face, while the opposite face is called the cold face. The hot face of the panel is often characterized by the presence of cavities that alternate with elevated parts, called ribs. The purpose of this configuration is to allow the fixation, on the hot face, of refractory protective material and/or to favor the retention of the furnace's load itself, which solidifies and tends to form a protective layer when cooled by contact with the cooled panel. The pipes that form the cooling water inlets and outlets leave the panel body by the cold face. The cooled panels used in blast-furnaces are commonly called “stave coolers”, and in this document, the name “cooled panel” will always be used, which also includes “stave coolers”. By current technique, each cooled panel has one or more independent cooling channels, and each cooling channel is connected to the furnace cooling water circuits through a coupling with the water inlet pipe and a coupling with the water outlet pipe. It is defined as coupling each device through which the connection is made between the panel cooling water circuits (which are part, indissolubly, of the panel) and the cooling water circuits of the furnace. The coupling must ensure watertightness based on the operating pressure of the cooling water and can be made with screw threads or other types of union and is characterized by the fact that it is a reversible connection and can be assembled and disassembled repeatedly with the use of common tools, without the need for cutting or welding operations. It is called a coupling set, the assembly consisting of an inlet coupling and an outlet coupling. From the point of view of the design and the manufacturing details, the part of the panel through which the water intake occurs, with its coupling, is equal to the part by which the output occurs, so that, by mentioning the constructive peculiarities of the pipes and other components of these regions of the panel, we will be referring to both the inlet and the outlet region.

The main parameter for defining the area of the unit cross-section and the number of cooling channels of each panel is the amount of thermal load that must be drained through the water. It is called total section of water passage in a panel, the area of the section of each channel, multiplied by the number of channels. In each panel, the need for a certain total section of passage can be obtained through a single channel, sufficiently wide, or through two or more channels, whose passage sections added together, reaches the value of the total section of passage required. The subdivision of the water flow into more channels, of smaller section, has the advantage of allowing a more effective, uniform and comprehensive cooling, besides allowing the reduction of the panel's thickness, with consequent reduction of cost. It also has the advantage of greater safety in case of unforeseen or accident, since if one of the channels presents leakage and has the water flow of interrupted, the reduction of efficiency in cooling the panel will be inversely proportional to the number of channels. On the other hand, a greater number of independent channels require more water inlet and outlet couplings and increased complexity of the external circuits of cooling water, as well as difficulty in assembly, disassembly and maintenance operations because of the lack of space and proximity between couplings. In addition, depending on the configuration of the furnace and the panel, a greater number of holes in the housing may be necessary, close to each other, weakening the furnace structure and increasing the complexity of the installations. These factors limit the number of independent circuits on each panel, despite the advantages that the greater number of circuits provide.

The optimizing configuration of water intakes and outputs of the cooling circuits of the panels and their respective couplings with the external pipe system of the blast furnace have been the subject of several studies and some patent applications. We can quote: U.S. Pat. No. 10,222,124 B2, from 5 Apr. 2019; U.S. Pat. No. 9,963,754 B2, from 8 Mar. 3, 2018; and European Patent 0 025 132 A1, from 18Mar. 1981. Even though the mentioned patents present distinct approaches and solutions, they all have in common the feature of making all the water inlet and outlet pipes converge in a single region of the panel, so that the passage of these tubes through the furnace shell can be carried out through a single window, which replaces the multiplicity of holes in the shell that should reach out in the case of each inlet or outlet pipe of the water passed individually through it. These solutions may favor the assembly and fixing of the panel in the furnace and in some cases allow a limited increase in the number of cooling channels, however they are not sufficient to make it feasible, in practice, a substantial increase in the number of cooling channels.

### SUMMARY

### Invention Objectives

The present invention refers to a new configuration of cooled panel used on the walls of blast furnaces and other industrial furnaces destined to the production of iron, steel and other basic materials, whose construction characteristics allow the achievement of the following objectives:

a) Improving effectiveness of panel cooling, by reducing temperatures in the hottest regions of the panel and obtaining lower average temperatures in the body and hot face, which allows an increase in the panel's utile lifetime. The panel will be able to work in temperature ranges in which the materials that compose it retain better mechanical characteristics and become less vulnerable to chemical damage. In addition, the lower temperature on the hot face favors the solidification of slag and other materials that contact the panel, favoring the formation of a solidified layer that protects its hot face and contributes to its durability. Another advantage provided by this protective layer is the reduction of heat dispersion, with consequent reduction of fuel or energy consumption per unit of production of the furnace;

b) Reducing thickness of the panel, with consequent reduction of its mass and cost, and increase of the usable space inside the furnace;

c) Reducing loss of cooling capacity of the panel in case of losing one or more cooling circuits. In the unfortunate occasion of an operational event such as abrasion, impact or localized overheating, causing a damage to the panel and consequently water leakage in one of the internal channels, forcing to stop the circulation of water in it, this lower loss allows, in certain circumstances, the panel to continue operating, even after the occurrence of the mentioned unforeseen event, avoiding unscheduled stops of the furnace and thus increasing its operational stability.

The objectives of the present invention are achieved with the provision of a panel whose feeding pipe(s) of the internal cooling channels are divided, after the couplings with the external circuit of the furnace cooling water, in two or more fully separated channels of smaller unit cross-section area, so that the panel body is crossed by a plurality of independent channels, in a greater quantity than the number of coupling sets. After making through the panel body separately, the plurality of channels get together in a single channel (for each coupling set) before the respective outlet coupling, so that the number of cooling water outlet couplings is equal to the number of inlet couplings. In this way it is possible to benefit from all the advantages resulting from the increase in the number of channels that run through the panel body, without having to face the relative disadvantages that, due to the current state of the technique, limit the increase in the number of these channels. Eliminating this limitation, the number of channels can be increased significantly without increasing, however, the number of coupling sets and the total section of water passage.

### Advantages of Invention

As a result, it will be possible to obtain, according to the current state of the technique, the following advantages related to the panels:

a) Significant reduction in the distance between cooling channels. This reduction in the distance between the channels results in a reduction in the average distance between each point of the panel and the cooling water, with consequent reduction of the average temperature in the body and on the hot face. The maximum distances between the water and the regions of the panel that are further away from it are also reduced, meaning that the so-called hot spots will be eliminated, which are the parts of the panel that are further away from the cooling water and therefore are more likely to become overheated;

b) Increased contact surface between cooling water and the channel wall: maintaining the same total section area of water passage, but subdividing it into a larger number of channels, the contact surface between the water and the channel wall is increased. This increase occurs in the square root ratio of the increase in the number of channels: being n the number of channels, S1 the contact surface when there is a single channel and Sn the contact surface when the same total section of passage is divided into n channels, the increase of the contact surface is expressed by the ratio Sn=S1×√n. That is: keeping the same total section of passage, but quadrupling the number of channels, the contact area between the water and the walls of the canals will double. Since the thermal exchange between the cooling water and the panel takes place through the water contact surface/channel wall, the increase of this surface directly interferes with the effectiveness of cooling.

c) Considering that the internal cooling channels of the panel are contained in the body of the panel, the smaller the diameter of the channels, the smaller the thickness of the body in which they should be contained. This fact allows that by increasing the number of channels and reducing at the same time its unit section, it is possible to reduce the thickness and, therefore, the mass and cost of the panels.

The advantages listed above allow to achieve the objectives of the present invention.

### BRIEF DESCRIPTION OF THE DRAWINGS

The present invention can be better understood by the detailed description in line with the attached figures.

FIG. 1 is a side-cut view of a blast furnace.

FIG. 1A is an enlarged view of part of the side cut of the blast furnace.

FIG. 2 is a horizontal-cut view of a blast furnace.

FIG. 2A is an enlarged view of part of the horizontal cut of the blast furnace.

FIG. 3 illustrates a front view of the cold face of a cooled panel made of rolled copper, according to the current state of the technique.

FIG. 3A illustrates a longitudinal cut view of a cooled panel made of rolled copper, according to the current state of the technique.

FIG. 3B illustrates a top view of a cooled panel made of rolled copper, according to the current state of the art.

FIG. 4 is a front view of the cold face of a cooled panel made of cast copper, according to the current state of the art.

FIG. 4A is a longitudinal cut view of a cooled panel made of cast copper, according to the current state of the art.

FIG. 4B is a top view of a cooled panel made of cast copper, according to the current state of the art.

FIG. 5 is a front view of the cold face of a cooled panel made of cast copper, according to the present invention.

FIG. 5A is a longitudinal cut view of a cooled panel made of cast copper, according to the present invention.

FIG. 5B is a top view of a cooled panel made of cast copper, according to the present invention.

FIG. 6 is a front view of the cold face of a cooled panel made of cast copper, according to the present invention, with channels parallel to the top and bottom edges.

FIG. 7 is a side-cut view of the water inlet (or outlet) assembly, according to the present invention.

FIG. 7A is a cross-section view of the sleeve containing the water inlet (or outlet) pipes, according to the present invention.

### DETAILED DESCRIPTION OF THE PRESENT INVENTION

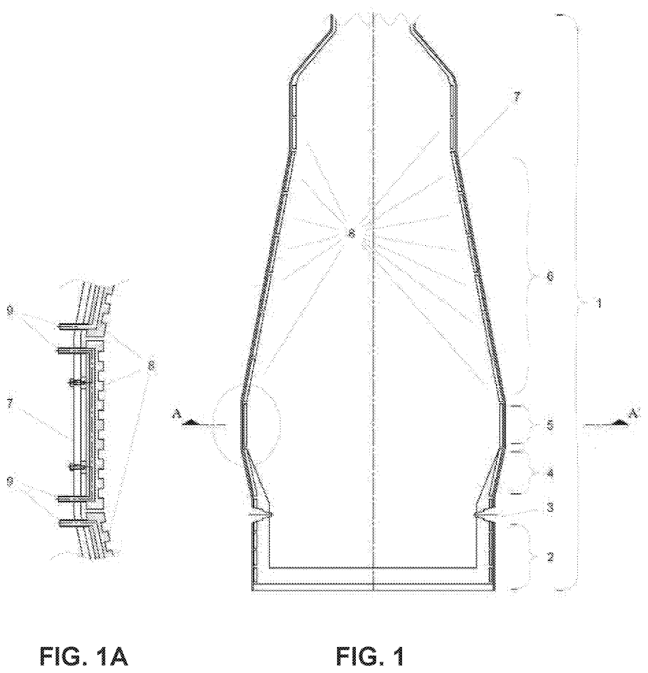

FIG. 1 exhibits a blast furnace 1, containing a hearth 2 where the liquid pig iron is accumulated, the region of the tuyeres 3 through which the hot air is blown into the furnace, a bosh 4, belly 5 and stack 6 on which the descending furnace load goes through the chemical reactions of ore reduction, besides heating and load melting. The furnace is sealed externally by a shell 7, which fully enfolds its inside, and to which cooled panels 8 are assembled on its inner face.

FIG. 1A illustrates a vertical cut of a partial set of cooled panels 8 according to the current state of the technique, fixed to the inner side of the shell 7, with their respective water inlet and outlet pipes 9 that go through the shell 7.

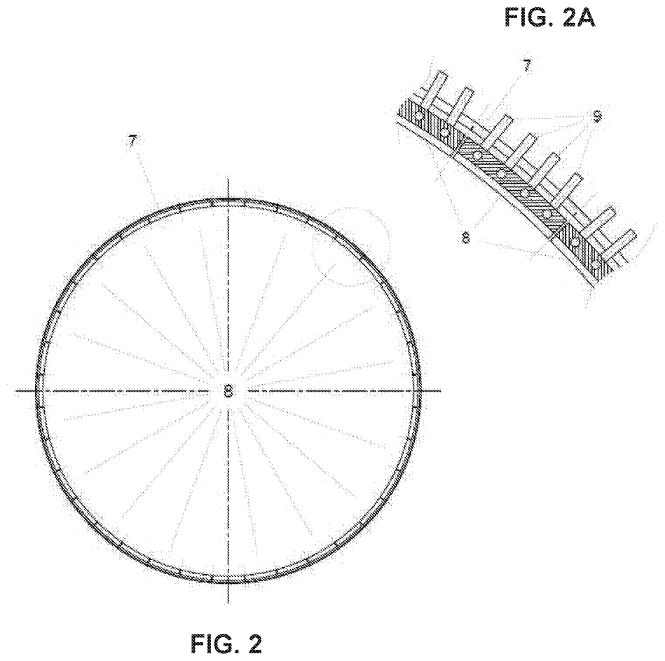

FIG. 2 illustrates the A - A section of a blast furnace where shell 7 and cooled panels 8 appear.

FIG. 2A illustrates the horizontal cut of a set of cooled panels 8 according to the current state of the technique, fixed to the inner side of the shell 7, with their respective water inlet and outlet pipes 9, that go through the shell 7.

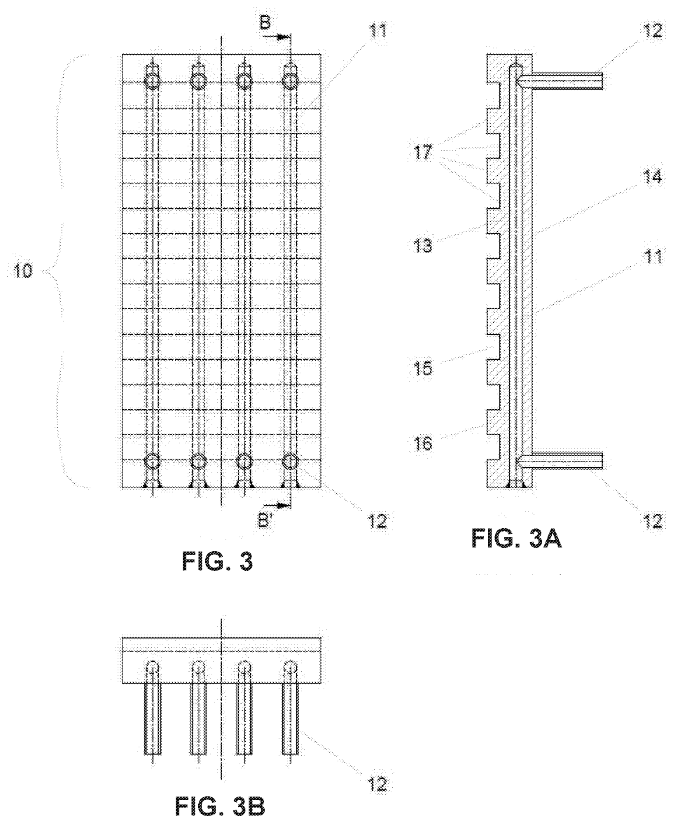

FIG. 3 illustrates the front view of the cold face of a rolled cooled panel 10, it's an example among the plurality of panels according to the current state of the technique, where, in vertical dashed lines, there are the internal cooling channels 11, obtained through hole machining, and the water inlet and outlet pipes 12.

FIG. 3A illustrates the longitudinal cut of a rolled cooled panel 10, according to the current state of the technique, made up of a body 13 obtained from a solid piece, an internal cooling channel 11 and the water inlet and outlet tubes 12 that leave the panel on the cold face 14. Also, in FIG. 3A, there are cavities 15 and ribs 16 that in some types of cooled panels characterize the hot face 17.

FIG. 3B illustrates the top view of a rolled cooled panel 10 according to the current state of the technique in which there are the water inlet or outlet tubes 12.

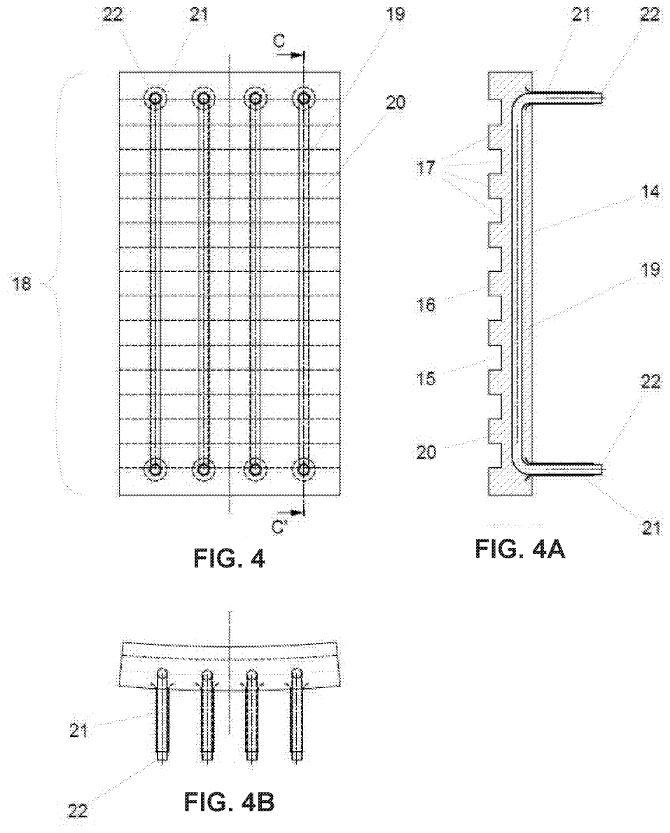

FIG. 4 illustrates the front view of the cold face of a cast cooled panel 18, it's an example among the plurality of panels according to the current state of the technique where, in vertical dashed lines, there are the internal cooling channels 19, consisting of steel or other metal alloy tubes, which are embedded in the cast body 20 of the panel. There are also the protection sleeves (tubes) 21, embedded in the cast copper body, which have the function of protecting the water inlet and outlet pipes 22 of the panels. The designation “embedded” will be used to inform that the part is fixed to the cast body during the casting process, in which the liquid metal solidifies and fixes the part of the piece in contact with it.

FIG. 4A illustrates the longitudinal cut of a cast cooled panel 18, according to the current state of the technique, in which there is a cast body 20, an internal cooling channel 19 and the water inlet and outlet tubes 22 that leave the panel on the cold face 14. Also, in FIG. 4A, there are the cavities 15 and ribs 16 that in some types of cooled panels, characterize the hot face 17, and the protection sleeves 21, embedded in the cast body, which protect the water inlet and outlet tubes of the panels.

FIG. 4B illustrates the upper view of a cast cooled panel 18 according to the current state of the technique in which the protection sleeves 21 appear, embedded in the cast body, and the water inlet or outlet tubes 22, each one protected by their respective protection sleeve (26).

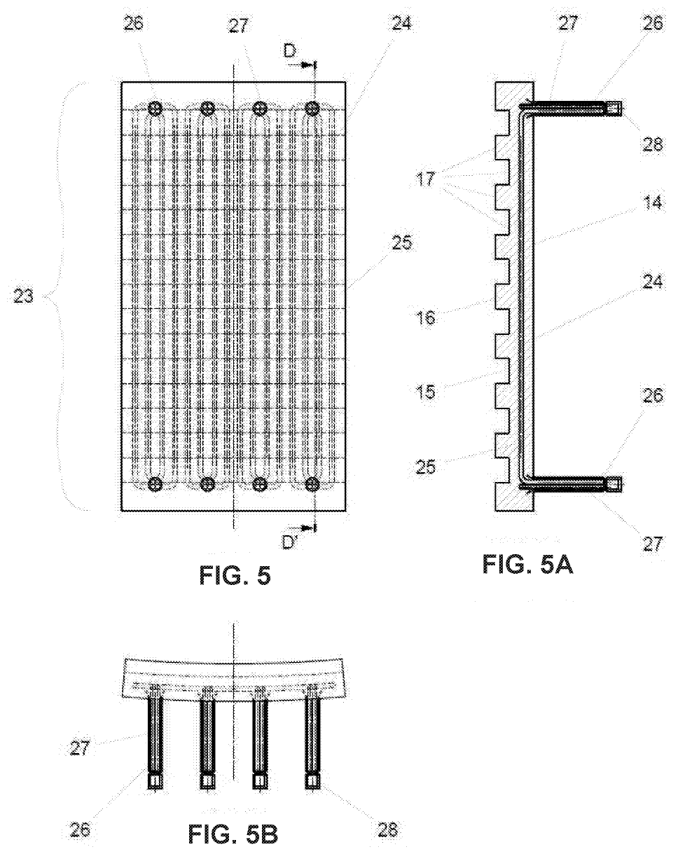

FIG. 5 illustrates the front view of the cold face of a cooled panel cast according to new design 23, where the internal cooling channels 24 appear in dashed lines, consisting of steel or other metal alloy tubes, which are embedded in the body of the panel 25. There are also the steel sleeves 26, embedded in the panel body, each of which has sufficient diameter to contain the tubes 27 that constitute the continuation of the internal cooling channels that converge into each cooling water outlet coupling or originate from each cooling water inlet coupling.

FIG. 5A illustrates the longitudinal cut of a cooled panel cast according to new design 23, in which it appears the cast body 25, an internal cooling channel 24 that longitudinally crosses the panel, and the cavities 15 and the ribs 16 that in some types of cooled panels, characterize the hot face 17. There are also, in FIG. 5A, the protection sleeves 26, embedded in the panel body, within which the inlet and outlet pipes 27 of the cooling water system of the panel are contained. Tubes 27 are joined by welding at its end to the panel's side of the coupling 28, made of steel or other metal alloy. In the case of the water outlet of the panel, the panel's side of the coupling 28 gathers the water flows from the internal cooling pipes 27 into a single duct and is connected by a single coupling to the furnace cooling system. In the case of the water inlet, the panel's side of the coupling 28 is connected by a single coupling, and the cooling water flow that comes from the panel's side of the coupling is branched into a plurality of tubes 27 entering the body of panel 25, cooling it.

FIG. 5B illustrates the upper view of a cast cooled panel 23, according to a new design, in which the protection sleeves 26 appear, embedded in the panel body, each of which contains the cooling water inlet or outlet tubes of the panel, and inside each protection sleeve, the tubes that derive from each inlet coupling or that are directed to each outlet coupling through the panel's side of the coupling 28.

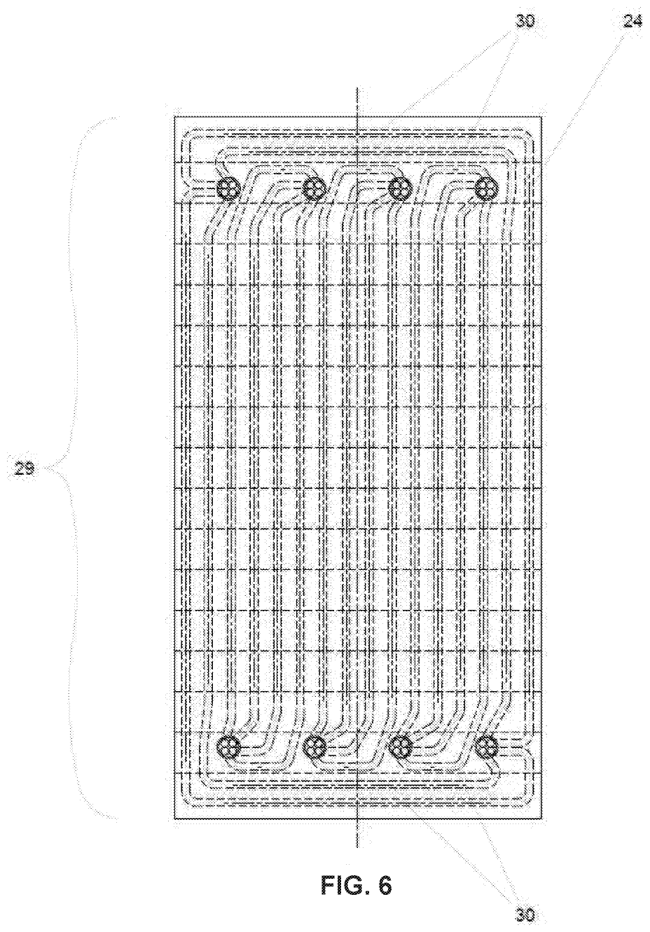

FIG. 6 illustrates the front view of the cold face of a cast cooled panel according to the new design, referred to in reference number 29, where the internal cooling channels 24 appear in dashed lines, consisting of steel or other metal alloy tubes, which are embedded in the cast body of the panel and which, in the configuration illustrated in this figure, pass horizontally 30 at the lower and upper ends of the panel, remaining parallel to the bottom and top edges of the panel, without deviations, interruptions or interposition of inlets or outlets of cooling water. This setting optimizes cooling at the top and bottom ends of the cooled panel.

Pipes that remain parallel to the bottom and top edges of the panel, without deviations, interruptions or interposition of coolant water inlets or outlets, originate in an inlet coupling located near one of the four corners of the panel and end at the coupling located near the opposite corner, and among the pipes that originate and end in these opposite couplings, one or more go around the panel clockwise and one or more go around the panel counterclockwise. In this way all other cooling channels in the panel body are contained in the perimeter delimited by the channels that are originated in the two mentioned couplings, located in opposite corners

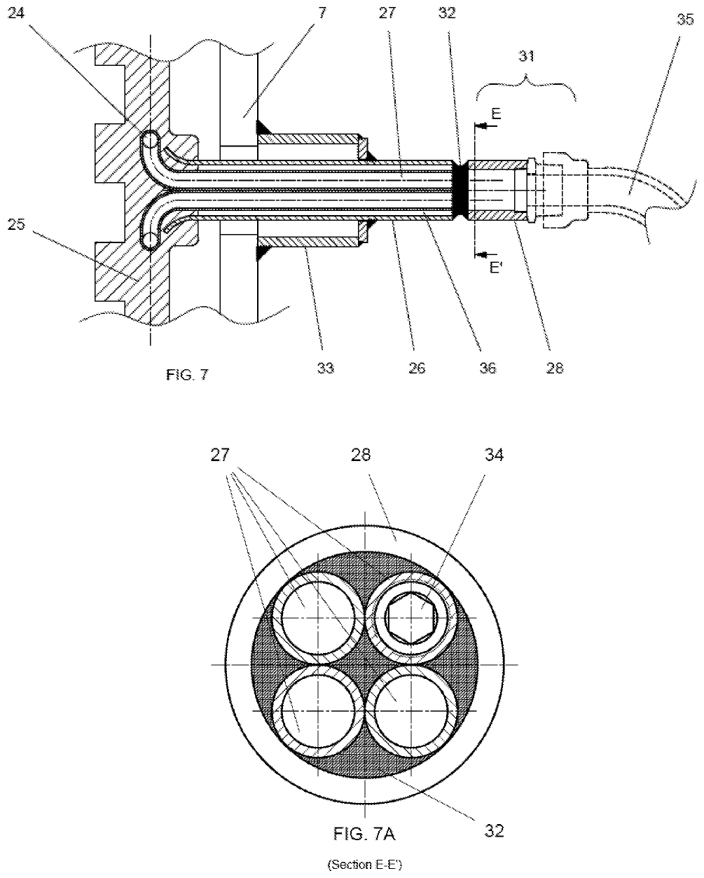

FIG. 7 illustrates the side detail view of the set of components that make up the inlet, or outlet, of the water and its connection to the furnace cooling system, where we have the internal cooling channels 24 of the cast cooled panel according to new design 23. The tubes 27 that form the inner channels converge and leave the casted body 25 inserted inside a protection sleeve 26. The connection between the end of tubes 27 to each other and to the panel's side of the coupling 28 is made by welding 32 or other method that guarantee the independency between the cooling water flow and the space created between the inside surface of the protection sleeve 26 and the outside surface of the tubes 27, avoiding leakages in case of some damage at the protection sleeve 26. For furnace gas sealing, the metal component 33 which can be rigid or flexible is welded to furnace housing 7 and protection sleeve 26. To avoid gas leaks, the protection sleeve 26 is preferably attached by welding to the pipes 27 inserted within it, in a certain way that, even if there is damage at the protection sleeve 26 region exposed to the inside furnace atmosphere, there won't be any gas leakage from the inside out. The coupling 31 connects the panel to the flexible pipe 35, which derives from the external cooling circuits of the furnace, constituting part of them.

FIG. 7A illustrates the front view, from the cold face side, the panel's side of the coupling 28, made of steel, the tubes that form the inner channels 27, and the connection weld 32. Also, it appears in this figure the cap 34. This cap is used to interrupt the flow of water in a channel that has eventually leaked, without impairing the flow of cooling water in the other channels connected to the same coupling. The cap can be installed to each tube 27 individually through the inner thread opening in it.

It should be noted that tubes 27 mentioned in the description of FIG. 5, 5A, 5B, 7 and 7A, whose function is to connect the embedded cooling channels 24 in the body 25 of the panel to the panel's side of the coupling 28 of the respective coupling 31, may have different sections from that circular illustrated in the figures and different also from the section of the internal cooling channels from which they originate.

It should be noted that variations in format, inclusion of windows or holes, modifications and alterations of the invention described here in this case are possible to those versed in the technique, without escaping the scope of the present invention or equivalents of this invention, and must be encompassed by the attached claims and their equivalents. There must also be included in the present invention “mixed” configuration panels, that is, panels that fit, in a part of their extension, within the criteria of the present invention and that have another part performed according to conventional criteria.

What is claimed is:

1. A cooled panel (23) for blast furnaces and other industrial furnaces, comprising: a body (25) cooled through cooling channels (24), at least one set of couplings (31) for connecting with the water system feed and return, a plurality of cooling channels (24) built-in the body (25) and a plurality of pipes (27) connecting the cooling channels (24) to each set of couplings (31); characterized by the fact that the panel's side of each coupling (31) breaches into a plurality of tubes (27) before getting in the panel body (25).

2. A cooled panel (23) for blast furnace and other industrial furnaces, according to claim 1, characterized by the fact that the panel's side (28) of each coupling (31) breaches into a plurality of tubes (27) before getting in the furnace (1), defining as a limit the line that limits the inside face of the furnace housing (7).

3. A cooled panel (23) for blast furnace and other industrial furnaces, according to claim 1, characterized by the fact that the body (25) is cast, rolled, forged or extruded.

4. A cooled panel (23) for blast furnaces and other industrial furnaces, according to claim 1, characterized by the fact that each set of couplings (31) has two cooling channels (24) built-in in the body (25).

5. A cooled panel (23) for blast furnaces and other industrial furnaces, according to claim 1, characterized by the fact that each set of couplings (31) has three or more cooling channels (24) built-in the body (25)

6. A cooled panel (23) for blast furnaces and other industrial furnaces, according to claim 1, characterized by the fact that each set of tubes (27), deriving from each set of cooling channels (24), that converge into a single coupling (31) when leaving the panel's body (25), is contained in a single protected sleeve (26), fixed to the panel (23).

7. A cooled panel (23) for blast furnaces and other industrial furnaces, according to claim 1, characterized by the fact that each set of pipes (27), deriving from each set of cooling channels that converge in a single coupling (31), when leaving the body (25) of the panel (23), is contained in a single protection sleeve (26), fixed to the body (25) of the panel (23), and that the connection between the tubes (27) exit from the protection sleeve (26) and the panel's side of the coupling (28) is made by welding (32).

8. A cooled panel (23) for blast furnaces and other industrial furnaces, according to claim 1, characterized by the fact that each set of pipes (27), deriving from each set of cooling channels (24) that converge in a single coupling (31), when leaving the body (25) of the panel (23), is contained in a single protection sleeve (26), fixed to the body (25) of the panel (23) and that the tubes (27), after leaving the protection sleeve (26), are connected sealed by welding (32) into a single coupling (31) that connects to the furnace cooling system.

9. A cooled panel (23) for blast furnaces and other industrial furnaces, according to claim 1, characterized by the fact that the passage between the panel's side of the coupling (28) and the space (36) between the inside surface of the protection sleeve (26) and the outside surface of the tubes (27) is sealed.

10. A cooled panel (23) for blast furnaces and other industrial furnaces, according to claim 5, characterized by the fact that the protection sleeve (27) has a circular or other section and is fixed to the body (25) by being embedded during casting process, by welding or by mechanical union, such as thread or flange with screws, or a combination of such fastening methods.

11. A cooled panel (23) for blast furnaces and other industrial furnaces, according to claim 1, characterized by the fact that the confluency between the inlet or outlet flows of water from internal cooling channels (24), when they come together to converge in each of the couplings (31), is made by making the plurality of pipes (27), relative to each coupling, converge within a single conduct, in the panel's side of the coupling 21, in which the cross-section of all pipes (27), whose water flows are directed to (or from) the same coupling, fit.

12. A cooled panel (23) for blast furnaces and other industrial furnaces, according to claim L characterized by the fact that each of the pipes (27) connecting the cooling channels (24) built-in the body (25) of the panel (23), to couplings (31), has its end towards the coupling directly visible and accessible throughout its section, when the coupling is disconnected.

13. A cooled panel (23) for blast furnaces and other industrial furnaces, according to claim 1, characterized by the fact that the area of the water passage section in each of the plurality of cooling channels (24) built-in the panel body (25) is less than half of the water passage section in the respective coupling (31).

14. A cooled panel (29) for blast furnaces and other industrial furnaces, according to claim 1, characterized by the fact that at least one channel (30) passes horizontally on the top edge of the panel and at least one channel passes horizontally on the bottom edge of the panel, remaining parallel to them along its extensions, without deviations or interruptions throughout the course between the curves that constitute the entrance and exit of the cooling channel in the parallel part to the respective edge and the fact that the channel (or channels) that run(s) through the top edge and the channel (or channels) that run(s) the bottom edge originate in the same coupling (31) of input and converge in the same output coupling (31).

15. A cooled panel (29) for blast furnaces and other industrial furnaces, according to claim 12, characterized by the fact that at least one of the channels (30) that passes on the top or bottom edges of the panel travels the panel clockwise while at least another of these channels travels the panel counterclockwise.

16. A cooled panel (23) for blast furnaces and other industrial furnaces, comprising: a body (25) cooled through cooling channels (24), at least one set of couplings (31) for connecting with the water system feed and return, a plurality of cooling channels (24) built-in the body (25) and a plurality of pipes (27) connecting the cooling channels (24) to each set of couplings (31); characterized by the fact that each set of couplings (31) breaches into 3 or more cooling channels (24) built-in in the panel's body.

17. A cooled panel (23) for blast furnace and other industrial furnaces, according to claim 16, characterized by the fact that the body (25) is cast, rolled, forged or extruded.

18. A cooled panel (23) for blast furnaces and other industrial furnaces, according to claim 16, characterized by the fact that each set of couplings (31) has three cooling channels (24) built-in in the body (25).

19. A cooled panel (23) for blast furnaces and other industrial furnaces, according to claim 16, characterized by the fact that each set of couplings (31) has four or more cooling channels (24) built-in in the body (25).

20. A cooled panel (23) for blast furnaces and other industrial furnaces, according to claim 16, characterized by the fact that the confluency between the inlet or outlet flows of water from internal cooling channels (24), when they come together to converge in each of the couplings (31), is made by making the plurality of pipes (27), relative to each coupling, converge within a single conduct, in the panel's side of the coupling (28), in which the cross-section of all pipes (27), whose water flows are directed to (or from) the same coupling, fit.

21. A cooled panel (23) for blast furnaces and other industrial furnaces, according to claim 16, characterized by the fact that each of the pipes (27) connecting the cooling channels (24) built-in the body (25) of the panel (23), to couplings (31), has its end towards the coupling directly visible and accessible throughout its section, when the coupling is disconnected.

22. A cooled panel (23) for blast furnaces and other industrial furnaces, according to claim 16, characterized by the fact that the area of the water passage section in each of the plurality of cooling channels (24) built-in the panel body (25) is less than half of the water passage section in the respective coupling (31).

23. A cooled panel (29) for blast furnaces and other industrial furnaces, according to claim 16, characterized by the fact that at least one channel (30) passes horizontally on the top edge of the panel and at least one channel passes horizontally on the bottom edge of the panel, remaining parallel to them along its extensions, without deviations or interruptions throughout the course between the curves that constitute the entrance and exit of the cooling channel in the parallel part to the respective edge and the fact that the channel (or channels) that run(s) through the top edge and the channel (or channels) that run(s) the bottom edge originate in the same coupling (31) of input and converge in the same output coupling (31).

24. A cooled panel (29) for blast furnaces and other industrial furnaces, according to claim 23, characterized by the fact that at least one of the channels (30) that travels on the top or bottom edges of the panel passes the panel clockwise while at least another of these channels travels the panel counterclockwise.

25. A cooled panel (23) for blast furnaces and other industrial furnaces, according to claim 6, characterized by the fact that the protection sleeve (27) has a circular or other section and is fixed to the body (25) by being embedded during casting process, by welding or by mechanical union, such as thread or flange with screws, or a combination of such fastening methods.

26. A cooled panel (23) for blast furnaces and other industrial furnaces, according claim 7, characterized by the fact that the protection sleeve (27) has a circular or other section and is fixed to the body (25) by being embedded during casting process, by welding or by mechanical union, such as thread or flange with screws, or a combination of such fastening methods.
